(19) United States
(12) Patent Application Publication
(10) Pub. No.: US 2023/0417912 A1
(43) Pub. Date: Dec. 28, 2023

(54) METHODS AND SYSTEMS FOR STATISTICAL VEHICLE TRACKING USING LIDAR SENSOR SYSTEMS

(71) Applicant: Board of Regents of the Nevada System of Higher Education, on behalf of the University of Nevada, Re, Reno, NV (US)

(72) Inventor: Hao Xu, Reno, NV (US)

(21) Appl. No.: 18/336,145

(22) Filed: Jun. 16, 2023

Related U.S. Application Data
(60) Provisional application No. 63/354,892, filed on Jun. 23, 2022.

(51) Int. Cl. G01S 17/66; G01S 17/89; G01S 7/48; G01S 17/58

(52) U.S. Cl. CPC G01S 17/66; G01S 17/89; G01S 7/4808; G01S 17/58

(57) ABSTRACT

Systems, methods and apparatus for object tracking using raw roadside LiDAR sensor data. In an embodiment, a computer processor of a computer receives raw LiDAR sensor data from a roadside LiDAR sensor and generates object data by filtering out background data from the raw LiDAR sensor data. The computer processor then clusters the object data into a plurality of clusters defining a plurality of objects, classifies each object of the plurality of objects, and tracks each classified object of the plurality of objects based on the discrete features data and on vehicle trajectory data collected over a predefined time period over a length of roadway.

### CROSS-REFERENCE TO RELATED APPLICATION

This U.S. Patent application claims the benefit of U.S. Provisional Patent Application No. 63/354,892 filed on Jun. 23, 2022, the entire contents of which are hereby incorporated by reference for all purposes.

### BACKGROUND

Light Detection and Ranging (LiDAR) is a remote sensing technology that emits laser light to illuminate and detect objects and map their distance measurements. Specifically, a LiDAR device targets an object with a laser and then measures the time for the reflected light to return to a receiver. LiDAR has been utilized for many different types of applications such as making digital 3-D representations of areas on the earth's surface and ocean bottom.

LiDAR sensors have been used in the intelligent transportation field because of their powerful detection and localization capabilities. For example, LiDAR sensors have been installed on autonomous vehicles (or self-driving vehicles) and used in conjunction with other sensors, such as digital video cameras and radar devices, to enable the autonomous vehicle to safely navigate along roads. It has recently been recognized that LiDAR sensors could potentially be deployed as part of the roadside infrastructure, for example, incorporated into a traffic light system at intersections or otherwise positioned in roadside locations as a detection and data generating apparatus. The detected traffic data can then be used by connected vehicles (CVs) and by other infrastructure systems to aid in preventing collisions and to protect non-motorized road users (such as pedestrians), to evaluate the performance of autonomous vehicles, and for the general purpose of collecting traffic data for analysis. For example, roadside LiDAR sensor data at a traffic light can be used to identify when and where vehicle speeding is occurring, and it can provide a time-space diagram which shows how vehicles slow down, stop, speed up and go through the intersection during a light cycle. In addition, roadside LiDAR sensor data can be utilized to identify “near-crashes,” where vehicles come close to hitting one another (or close to colliding with a pedestrian or a bicyclist), and thus identify intersections or stretches of roads that are potentially dangerous.

Connected-Vehicle (CV) technology is an emerging technology that aims to reduce vehicle collisions and provide energy efficient transportation for people. CV technology allows bi-directional communications between roadside infrastructure and the connected vehicles (road users) for sharing real-time traffic and/or road information and provide rapid responses to potential events and/or to provide operational enhancements. However, some currently deployed CV systems suffer from an information gap concerning information or data about unconnected vehicles, pedestrians, bicycles, wild animals and/or other hazards.

Roadside LiDAR sensor systems can potentially be utilized to close the information gap that typical CV systems suffer from. In particular, roadside LiDAR systems can be incorporated into the roadside infrastructure to generate data concerning the real-time status of unconnected road users within a detection range to thus provide complementary traffic and/or hazard information or data. For example, LiDAR sensor systems can be utilized to detect one or more vehicles that is/are running a red light and/or pedestrians who are crossing against a red light and share that information with any connected road users.

A common misconception is that the application of roadside LiDAR sensors is similar to the application of on-board vehicle LiDAR sensors, and that therefore the same processing procedures and/or algorithms utilized by on-board LiDAR systems could be applicable to roadside LiDAR systems (possibly with minor modifications). However, on-board LiDAR sensors mainly focus on the surroundings of the vehicle and the goal is to directly extract objects of interest from a constantly changing background. In contrast, roadside LiDAR sensors must detect and track all road users in a traffic scene against a static background. Thus, infrastructure-based, or roadside LiDAR sensing systems have the capability to provide behavior-level multimodal trajectory data of all traffic users, such as presence, location, speed, and direction data of all road users gleaned from raw roadside LiDAR sensor data. In addition, low-cost sensors may be used to gather such real-time, all-traffic trajectories for extended distances, which can provide critical information for connected and autonomous vehicles so that an autonomous vehicle traveling into the area covered by a roadside LiDAR sensor system becomes aware of potential upcoming collision risks and the movement status of other road users while the vehicles are still at a distance away from the area or zone. Thus, the tasks of obtaining and processing trajectory data are different for a roadside LiDAR sensor system than for an on-board vehicle LiDAR sensor system.

Accordingly, for infrastructure-based or roadside LiDAR sensor systems, it is important to detect target objects in the environment quickly and efficiently because fast detection speeds provide the time needed to determine a post-detected response, for example, by an autonomous vehicle to avoid a collision with other road users in the real-world. Detection accuracy is also a critical factor to ensure the reliability of a roadside LiDAR based system.

Tracking is referred to as detecting the same object in continuous frames to obtain the object's trajectory. The purpose of tracking is to obtain each road user's trajectory frame by frame, so that the direction, the speed, a movement prediction, and the like can be calculated for the object as it changes locations. Obtaining kinematic data (continuous speeds and movement directions) of road users is critical for assisting connected-autonomous vehicles, for dynamic traffic signal control, and for proactive collision warning systems. Trajectories are also important for traffic performance analysis (offline applications) purposes to provide an understanding of the movement behavior of vehicles and other road users and for designing traffic infrastructure based on such a movement behavior analysis. In this regard, roadside LiDAR sensors deployed at fixed locations (e.g., road intersections and along road medians) provide a good way to record trajectories of all road users over the long term, regardless of illumination conditions. Traffic engineers can then study the historical trajectory data provided by the roadside LiDAR system at multiple scales to define and extract near-crash events, identify traffic safety issues, and recommend countermeasures and/or solutions.

It should be noted that LiDAR systems also offer certain advantages over video and vision-based systems. In particular, the analysis of infrastructure-based video data requires significantly more processing and computing power. Also, bad illumination conditions such as nighttime recordings adversely affect video quality, but such conditions do not affect the quality of LiDAR system data. Roadside LiDAR systems therefore have the advantage over other sensing and detection technologies (such as inductive loop, microwave radar, and video camera technologies) in the ability to get trajectory-level data and improved performance in accurate detection and tracking of pedestrians and vehicles even under low-light conditions. While LiDAR sensors collect data in the form of cloud points, vision-based systems collect data mostly in the form of high-resolution images. Cloud points have relatively lower density but greater spatial measurement accuracy than high-resolution images.

The inventors have recognized that there is a need for providing improved methods and systems for utilizing roadside LiDAR data for vehicle tracking purposes.

### BRIEF DESCRIPTION

Presented are methods, apparatus and systems for object tracking using raw roadside LiDAR sensor data. In an embodiment, a computer processor of a computer receives raw LiDAR sensor data from a roadside LiDAR sensor and then generates object data by filtering out background data from the raw LiDAR sensor data. The computer processor then clusters the object data into a plurality of clusters defining a plurality of objects wherein each object may include discrete features data, classifies each object of the plurality of objects, and tracks each classified object of the plurality of objects based on the discrete features data and on vehicle trajectory data collected over a predefined time period over a length of roadway.

In some implementations, prior to receiving the raw LiDAR sensor data, the computer processor generates a grid of cells defining a grid environment in which objects travel, generates a look-up map by assigning a unique index to each cell of the grid of cells, and generates a reverse-look-up map by assigning a unique inverse index to each cell of the grid of cells. The computer processor may also generate a frequency-grid-map that captures movement of objects from one cell to another cell within the grid environment and may also receive verified historical trajectory data that captures the frequencies of objects moving from one cell to another cell within the grid environment.

The discrete features data may include at least one of points, collections of edges, and lines, and the predefined time period may be twenty-four (24) hours over the length of roadway. In addition, generating the object data may include the computer processor identifying, based on spherical map input data, a plurality of core points that are within a window size, labeling the core points on a spherical map, joining the core points as different clusters according to connectivity of the core points, and determining that a non-core point is within a window of a core point and that the absolute value of the non-core point minus a core point is less than the window size. The computer processor may then specify a cluster label for the non-core point and generate a labeled spherical map of object data. Also, after joining the core points as different clusters the computer processor may determine at least one of that a non-core point is not within a window of a core point or that the absolute value of the non-core point minus a core point is greater than the window size, and then label the non-core point as noise.

Classifying each object of the plurality of objects may include the computer processor determining a reference point for each cluster, and then classifying, based on the reference point for each cluster, different road users by utilizing at least one feature-based classification process combined with prior trajectory information.

Another aspect is directed to a traffic data processing computer for tracking vehicles using raw roadside LiDAR sensor data. In some disclosed embodiments, the traffic data processing computer includes a traffic data processor, a communication device operably connected to the traffic data processor; and a storage device operably connected to the traffic data processor. The storage device may store processor executable instructions which when executed cause the traffic data processor to receive raw LiDAR sensor data from a roadside LiDAR sensor, generate object data by filtering background data from the raw LiDAR sensor data, cluster the object data into a plurality of clusters defining a plurality of objects wherein each object may include discrete features data, classify each object of the plurality of objects, and then track each classified object of the plurality of objects based on the discrete features data and on vehicle trajectory data collected over a predefined time period over a length of roadway.

The storage device of the traffic data processing computer may also include processor executable instructions which when executed cause the traffic data processor to generate a grid of cells defining a grid environment in which objects travel, generate a look-up map by assigning a unique index to each cell of the grid of cells, and generate a reverse-look-up map by assigning a unique inverse index to each cell of the grid of cells. The storage device may also store further processor executable instructions which when executed cause the traffic data processor to generate a frequency-grid-map that captures movement of objects from one cell to another cell within the grid environment. In addition, the storage device of the traffic data processing computer may store further processor executable instructions which when executed cause the traffic data processor to receive verified historical trajectory data that captures the frequencies of objects moving from one cell to another cell within the grid environment. In some implementations, the discrete features data comprises at least one of points, collections of edges, and lines, and the predefined time period may be twenty-four (24) hours over the length of roadway.

In some implementations of the traffic data processing computer, the processor executable instructions for generating the object data may include instructions which when executed cause the traffic data processor to identify, based on spherical map input data, a plurality of core points that are within a window size, label the core points on a spherical map, join the core points as different clusters according to connectivity of the core points, determine that a non-core point is within a window of a core point and that the absolute value of the non-core point minus a core point is less than the window size, specify a cluster label for the non-core point, and generate a labeled spherical map of object data. The processor executable instructions for joining the core points as different clusters may also include instructions which when executed cause the traffic data processor to determine at least one of that a non-core point is not within a window of a core point or that the absolute value of the non-core point minus a core point is greater than the window size and label the non-core point as noise.

In yet some other embodiments of the traffic data processing computer, the processor executable instructions for classifying each object of the plurality of objects may include instructions which when executed cause the traffic data processor to determine a reference point for each cluster, and classify, based on the reference point for each cluster, different road users by utilizing at least one feature-based classification process combined with prior trajectory information.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1A depicts a LiDAR sensor system installation located at an intersection of roadways in accordance with some embodiments of the disclosure;

FIG. 1B illustrates another embodiment of a roadside LiDAR sensor system situated alongside a road, or alongside a road segment, in accordance with embodiments of the disclosure;

FIG. 1C illustrates a portable roadside LiDAR sensor system located along a road segment in accordance with some embodiments of the disclosure;

FIG. 1D illustrates another embodiment of a portable roadside LiDAR sensor system which may be located along a road segment in accordance with some embodiments of the disclosure;

FIG. 2 is a functional diagram illustrating the components of a portable roadside LiDAR sensor system in accordance with some embodiments of the disclosure;

FIG. 3 is a functional diagram illustrating the components of a permanent roadside LiDAR sensor system embodiment in accordance with the disclosure;

FIG. 3A is a flowchart which illustrates an innovative Fast Spherical Projection based Clustering (FSPC) algorithm in accordance with the disclosure;

FIG. 4A is a flowchart of an initialization process in accordance with some embodiments of the disclosure;

FIG. 4B is a flowchart of an object tracking process using roadside LiDAR sensor data in accordance with some embodiments of the disclosure;

FIGS. 5A and 5B illustrate a first mapping at 0.1 second and a second mapping at 0.2 seconds, respectively, of a vehicle in accordance with some embodiments of the disclosure; and

FIG. 6 is a block diagram of a traffic data processing computer in accordance with some embodiments of the disclosure.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of the embodiments may be practiced without some or all of the specific details. In other instances, well-known process operations have not been described in detail in order not to unnecessarily obscure novel aspects. In addition, terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used.

In general, and for the purposes of introducing concepts of embodiments of the present disclosure, disclosed herein are methods for processing raw roadside LiDAR (Light Detection and Ranging) sensor data for use in the precise detection and tracking of objects such as, for example, vehicles traveling on a road. Examples of vehicles that may be detected and tracked include, but are not limited to, automobiles, motorcycles, trucks and vans. In some embodiments, methods for object tracking involve creating a statistical mapping of frequencies between any two cells within a grid representation of the environment, which may be created using previous knowledge of verified vehicle trajectories. In addition, in some implementations the method is enhanced by combining it with a traditional distance-based tracking method. Thus, some embodiments of the methods and systems disclosed herein advantageously provide an improved framework for vehicle tracking as compared to previously implemented methods.

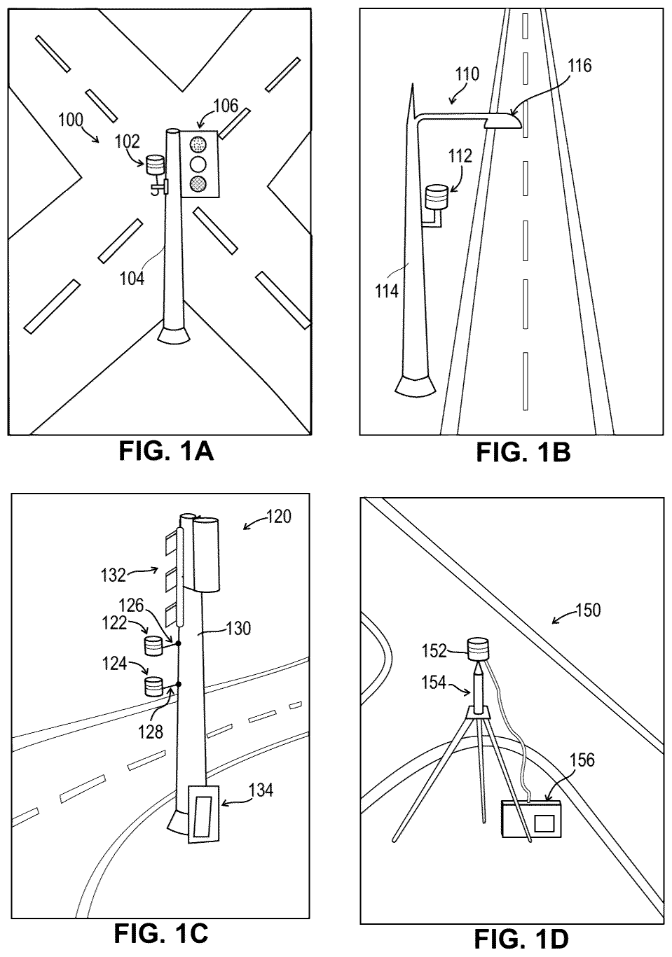

FIGS. 1A to 1D depict several different types of roadside LiDAR sensor system deployments in accordance with some embodiments. LiDAR sensors use a wide array of infra-red lasers paired with infra-red detectors to measure distances to objects, and there are several companies that manufacture LiDAR sensor products, such as the Ouster® Company of San Francisco, California. In some installations, the LiDAR sensors are securely mounted within a compact, weather-resistant housing and include an array of laser/detector pairs that spin rapidly within the fixed housing to scan the surrounding environment and provide a rich set of three-dimensional (3D) point data in real time. The lasers themselves may be used for other applications, for example in barcode scanners in grocery stores and for light shows and are eye-safe (i.e., will not damage human eyes). The selection of a particular type of LiDAR sensor to utilize depends on the purpose or application, and thus factors that may be considered include the number of channels (resolution of LiDAR scanning), the vertical field of view (FOV), and the vertical resolution of laser beams. In embodiments, a LiDAR sensor may have anywhere from one (1) to one-hundred and twenty-eight (128) laser beams that are rotated 360 degrees to measure the surrounding environment in real-time. In general, LiDAR sensors with more laser channels, larger vertical FOV, and higher resolution are more productive in data collection.

FIG. 1A depicts an example of a permanent LiDAR sensor system installation 100 located at an intersection of roadways. As shown, the LiDAR sensor 102 is affixed to a traffic light pole 104 that includes a traffic light 106. In some implementations, raw sensor data generated by the roadside LiDAR sensor 102 may be transmitted via a wired or wireless connection (not shown), for example, to an edge computer (not shown) and/or to a datacenter that includes one or more server computers (not shown) for processing.

FIG. 1B illustrates another embodiment of a roadside LiDAR sensor system 110 situated alongside a road, or alongside a road segment, in accordance with the disclosure. The LiDAR sensor 112 is attached to a lamppost 114 that in this case includes a streetlamp 116. Like the LiDAR sensor system 100 of FIG. 1A, in some embodiments the sensor data generated by the roadside LiDAR sensor 112 may be transmitted via a wired or wireless connection (not shown), for example, to an edge computer (not shown) and/or to a datacenter that includes one or more server computers (not shown) for processing.

FIG. 1C illustrates a portable roadside LiDAR sensor system 120 located along a road segment in accordance with some embodiments. In this implementation, a first LiDAR sensor 122 and a second LiDAR sensor 124 may be removably affixed via connecting arms 126 and 128, respectively, to a traffic light post 130 below a traffic light 132 (or traffic signal head) as shown and may be reachable for portable system installation and removal. The LiDAR sensor system 120 includes a portable sensor data processing unit 134 which may also be removably attached to the traffic light post 130. The portable sensor data processing unit 134 may contain electronic circuitry (not shown) configured to process the data generated by both the roadside LiDAR sensors 122 and 124 on-site, and/or may transmit the sensor data and/or the processed data to a datacenter that includes one or more server computers (not shown). In some implementations, such a datacenter may utilize the sensor data for further processing. The roadside LiDAR sensors assembly (sensors 122, 124 along with the connecting arms 126,128 and data processing unit 134) may be left in place to gather traffic related data for a specified duration, which may be hours, days, weeks, or months.

FIG. 1D illustrates another embodiment of a portable roadside LiDAR sensor system 150 which may be located along a road segment in accordance with some embodiments. In this implementation, a first LiDAR sensor 152 is supported by a tripod 154 that is placed alongside a road or, for example, in a road median (not shown). The LiDAR sensor system 150 may also include a portable sensor data processing unit 156 which may store and/or process sensor data generated by the roadside LiDAR sens or 152. In some implementations, the LiDAR sensor system 150 is a standalone unit which is left on-site for only short periods of time, such as for a few hours, and then transported to a datacenter or otherwise operably connected to a host computer for processing and/or analyzing the traffic data captured by the roadside LiDAR sensor 152.

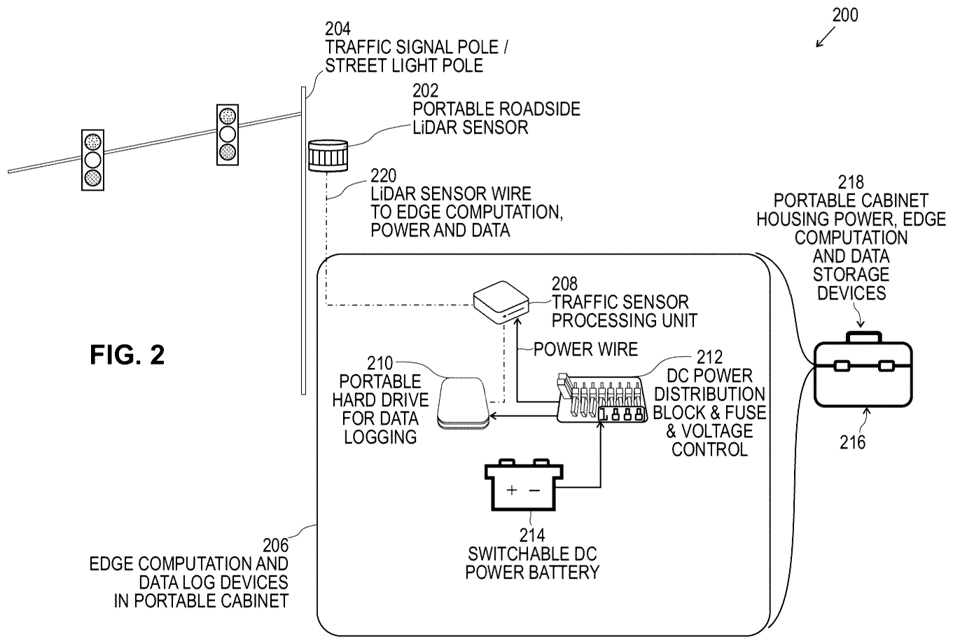

FIG. 2 is a functional diagram illustrating the components of a portable roadside LiDAR sensor system 200 in accordance with some embodiments. A portable roadside LiDAR sensor 202 is affixed to a traffic signal pole 204 (which may also be a streetlight pole). Edge processing circuitry 206 may include a traffic sensor processing unit 208 (or traffic sensor CPU), a portable hard drive 210, power control circuitry 212 and a battery 214 all housed within a hard-shell case 216 having a handle 218. The traffic sensor processing unit or CPU 208 may be a computer or several computers or a plurality of server computers that work together as part of a system to facilitate processing of roadside LiDAR sensor data. In such a system, different portions of the overall processing of such roadside LiDAR sensor data may be provided by one or more computers in communication with one or more other computers such that an appropriate scaling up of computer availability may be provided if and/or when greater workloads occur, for example if a large amount of roadside traffic data is generated and requires processing.

Referring again to FIG. 2, a wired or wireless connection 220 may electronically connect the roadside LiDAR sensor 202 to the edge processing circuitry. In some implementations, the traffic sensor processing unit 208 receives raw traffic data from the roadside LiDAR sensor 202, processes it and stores the processed data in the portable hard drive 210. In some embodiments, the power control circuitry 212 is operably connected to the battery 214 and provides power to both the traffic sensor processing unit 208 and the portable hard drive 210 as shown. In some implementations, the edge processing circuitry 206 may be physically disconnected from the roadside LiDAR sensor 202 so that the hard-shell case 216 can be transported to a datacenter (not shown) or otherwise operably connected to a host or server computer (not shown) for processing and/or analyzing the traffic data captured by the roadside LiDAR sensor 202.

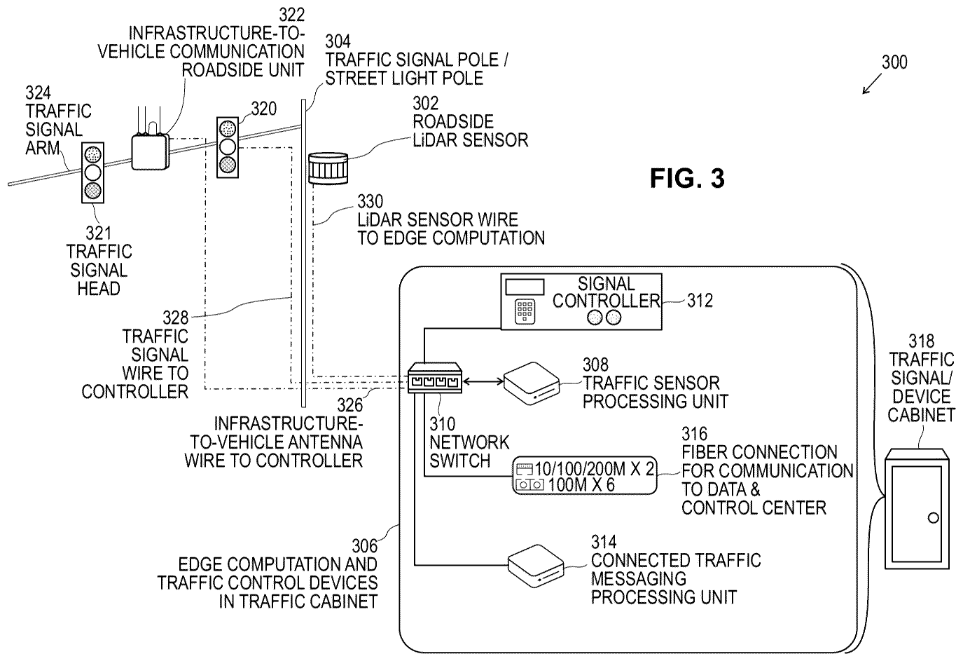

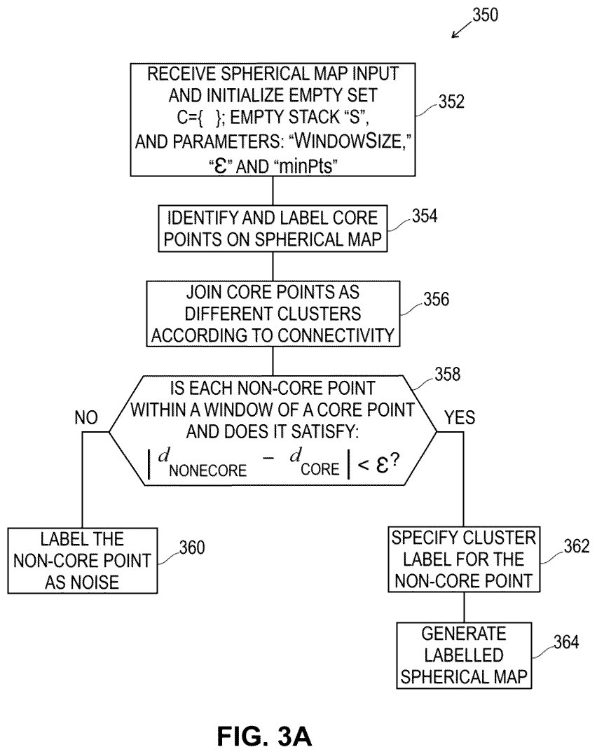

FIG. 3 is a functional diagram illustrating the components of a permanent roadside LiDAR sensor system 300 in accordance with some embodiments. A roadside LiDAR sensor 302 is affixed to a traffic signal pole 304 (which may also be a streetlight pole) and is operably connected to edge processing circuitry 306 which, in some implementations, may be housed within a roadside traffic signal device cabinet 318. In some embodiments the roadside traffic signal device cabinet 318 is locked and hardened to safeguard the electronic components housed therein against vandalism and/or theft.

Referring again to FIG. 3, in some embodiments the edge processing circuitry 306 includes a network switch 310 that is operably connected to a traffic sensor processing unit 308 (or traffic sensor CPU), to a signal controller 312, to a connected traffic messaging processing unit 314, and to a fiber-optic connector 316 (and in some embodiments to a fiber-optic cable, not shown). In some implementations, in addition to being operably connected to the roadside LiDAR sensor 302, the network switch 310 is also operably connected to the traffic light 320 and to a transmitter 322. The transmitter is operable to function as an infrastructure-to-vehicle roadside communication device and may utilize the Long Term Evolution (LTE or 4G) protocol, and/or the 5G standard, and/or a Wifi protocol for wireless data transmission.

In the illustrated embodiment of FIG. 3, the traffic lights 320 and 321, and the transmitter 322, are affixed to a traffic signal arm 324 that is typically positioned so that these devices are arranged over a roadway, and typically over an intersection of roadways. In some implementations, the transmitter 322, the traffic light 320, and the roadside LiDAR sensor 302 are electrically connected to the network switch 310 via wires or cables 326, 328 and 330, respectively. However, in other implementations these devices or components may instead be wirelessly connected to the network switch 310. In some embodiments, the traffic sensor processing unit 308 receives raw traffic data from the roadside LiDAR sensor 302, processes it and operates with the connected traffic messaging processing unit 314 and transmitter 322 to transmit data and/or instructions to a connected vehicle (CV) which may be traveling on the road and approaching the intersection (not shown). In addition, the traffic sensor processing unit 308 may transmit data via the fiberoptic connector 316 to a remote data and control center (not shown) for further processing and/or analysis.

The roadside LiDAR sensing systems described above with reference to FIGS. 1A through 1D, FIG. 2 and FIG. 3 may provide behavior-level, multimodal trajectory data of all traffic users, including but not limited to cars, buses, trucks, motorcycles, bicycles, vans, wheelchair users, pedestrians and various wildlife. Such real-time, all-traffic trajectories data can be gathered for extended distances, and in some implementations this critical information may be transmitted in real-time to connected vehicles and/or to autonomous vehicles. In an example, the behavior-level, multimodal trajectory data may be used by autonomous vehicles traveling into the area covered by the roadside LiDAR sensor system to be made aware potential upcoming collision risks, and/or to be made aware of the movement status of other vehicles on the road while still being at a distance away from the road segment or intersection.

Background filtering, object detection, object classification, and real-time tracking of moving objects are the four fundamental steps involved when processing data from a roadside LiDAR system. Thus, given roadside LiDAR sensor data, background filtering is utilized to filter out background objects such as buildings and trees from the moving objects which are of interest. The point clouds corresponding to different objects must then be identified, the different objects are next classified, and then the moving objects are tracked.

In some implementations, an algorithm may be used that performs the background filtering element, and it may involve frame aggregation, points statistics, threshold learning, and real-time filtering. In some embodiments, multiple LiDAR data frames are aggregated, and then the 3D space is divided into cubes wherein if the number of total laser points in a cube is greater than a threshold amount (which may be automatically learned) then the cube will be identified as a background space cube. Such a background space cube is then used to exclude background points.

Another background filtering method may be executed based on a comparison of the distances between raw LiDAR data points and pre-saved or stored background datapoints. According to the working principle of LiDAR sensors, the target object is measured by laser beams, the 3D distance between the target object and the LiDAR sensor is always less than the 3D distance between the background object and the LiDAR sensor if these two objects are within the same azimuth interval and are measured by the same laser beam.

In embodiments described herein, a spherical map may be established after the LiDAR sensor completes a 360-degree spin. The spherical map is defined as an array whose column refers to different discretized azimuth channels and each row refers to the different laser channels. Each cell for the spherical map records the returned distance value according to corresponding azimuth and laser channels. For example, at the beginning of each frame, an empty 1800×32 array may be created for use as a container of the spherical map. When a data block (a column of data array with 1×32) is transmitted from the LiDAR sensor, the azimuth value is first discretized as the azimuth channel (for 0-1799), which is also regarded as the column index of the spherical map. Next, the obtained data block is written into the container of the spherical map according to a discretized azimuth channel. Once a roll-over (a complete 360-degree) azimuth is detected, the container is output as the spherical map of the current frame.

FIG. 3A is a flowchart illustrating an innovative Fast Spherical Projection based Clustering (FSPC) process 350 which may be utilized by a computer processor for cloud points clustering and object detection in accordance with this disclosure. The innovative FSPC process may be thought of as being somewhat similar to a DBSCAN process, but details concerning their implementations are different.

The DBSCAN process is one of the most prevalent algorithms used for clustering because it can identify an arbitrary shape of clusters based on the spatial density while also ruling out noise. In general, two parameters are involved when utilizing the DBSCAN process: “minPts” data (the minimum amount of sample points needed to establish a core point) and “eps” data (neighborhood searching radius). These two parameters are taken together to identify the dense point clusters.

A DBSCAN process operates as follows: 1) for each input point, search the neighborhoods within the eps-radius and mark points whose number of neighborhoods within the eps-radius satisfy the minPts threshold as core points; 2) identify the connected components of core points based on the direct and indirect interconnection of neighborhoods and ignore the non-core points; and 3) assign each non-core point to a nearby connected component if the non-core point is within the eps-radius, otherwise the non-core point(s) is/are labeled as noise.

Referring again to FIG. 3A, when utilizing the FSPC process 350 neighborhood searching is modified to improve the time complexity. In contrast to the DBSCAN method, the FSPC method searches the neighborhoods on a spherical map. Thus, the spatial relationship between different points can be directly inferred from the spherical map given the distance information of each point and corresponding index on the spherical map.

Accordingly, with reference to FIG. 3A a processor receives 352 an input (for the FSPC process) of a Spherical Map D_{r,c} and then initializes an empty set C, an empty stack S, a Window Size, a parameter ε and minPts. Next, the processor identifies and labels 354 all the core points on the Spherical Map Dr,c, wherein each core point d_{core}, at least the minPts and the foreground points, d_{c,r}, are within the Window Size and thus satisfy the equation:

|d_{c,r}−d_{core}|<ε

Next, the processor joins 356 all the core points as different clusters according to the connectivity of the core points. The processor then determines 358 if each non-core point is within the window of a core point and satisfies the following equation:

|d_{noncore}−d_{core}|<ε

If a non-core point is not within the window of a core point and/or does not satisfy the above equation then the non-core point is labeled 360 as “noise.” If a non-core point is within the window of a core point and satisfies the above equation then a cluster label is specified 362 for that core point. Next, the processor generates 364 a labeled spherical map.

After clustering, object classification is performed. In some embodiments, object classification includes determining a reference point in the x-y plane that specifies the position of each cluster. The reference point is used in classification and tracking. For each cluster, all of the clustered points are projected onto the x-y plane to find their bounding box or the minimum sized rectangle that covers all clustered points. In some implementations, the mean center of each cluster is used as the reference point for pedestrians and bounding boxes are used as the reference for vehicles.

In an implementation, a feature-based classification process is combined with prior trajectory information to classify different road users using roadside traffic data acquired by a roadside LiDAR sensor. For example, four classifiers may be used and by updating critical features based on prior trajectory information, the accuracy of classification can be greatly improved, especially for classes with a small number of observations. In particular, the “AdaBoost” and “RUSBoost” classifiers have shown superior performance in achieving the recall rate of a vehicle (100%), a pedestrian (99.96%), a cyclist (99.74%), and a wheelchair (99.43%). In an embodiment, the four classifiers which are utilized include: 1) an Artificial Neural Network, 2) a Random Forest classifier, 3) an Adaptive Boosting (AdaBoost) classifier, and 4) Random Under sampling Boosting (RUSBoost) classifier.

Assuming background filtering and object clustering tasks have been performed, then the methods disclosed herein may focus on tracking of objects such as vehicles. Object tracking is the procedure of identifying the same object in continuous data frames and is necessary for generating continuous trajectory of each road user and calculating movement speeds and directions. In some embodiments, the disclosed approach relies on vehicle trajectory data, and not merely at a single point and/or at a fixed time. As discussed below, the disclosed methods compare favorably against other popular tracking methods such as the nearest neighbor distance-based and/or Kalman Filter methods.

Object tracking techniques include region-based tracking, contour-based tracking, (discrete) feature point-based tracking, and combined tracking methods. There also exist some map-matching algorithms [“mapmatching”] where current positions or even portions of the trajectory are mapped to the road network which is often represented by a vector representation. In region-based tracking, objects are represented based on their color or reflection intensity values, and tracking relies on the color/reflection distribution of the tracked object. In contour-based tracking, the objects are tracked by considering their outlines as boundary contours. In feature point-based tracking, feature points describe the objects.

In contrast, embodiments disclosed herein perform tracking using discrete features such as points, collections of edges, and lines. Utilizing discrete features for object tracking is reliable given free-flow traffic. However, in situations of high density traffic when the discrete features of one or more objects are partially occluded, tracking is more difficult to perform accurately.

The goal of the disclosed tracking method is to produce an object tracking system that is robust in tracking objects such as vehicles with fewer roadside LiDAR data points, and/or to track objects such as vehicles that may move close to each other. Some of the important challenges to overcome include occlusions, changes in shape of object clusters, and clustering errors.

The nearest distance/neighbor method is a simple approach that groups moving objects such as vehicles based on the closeness of their distances between frames. While this method works in many cases, it can result in mismatching objects when the following scenario occurs: given two lanes with two cars side-by-side with each other that are travelling in the same direction, the tracking algorithm can match the first car with the second car, and vice versa due to their closeness to each other as they travel.

In testing the distance-based method, it is found that the algorithm cannot distinguish between two objects when one trajectory ends and another trajectory begins. Therefore, jumps from one object trajectory to a different object trajectory can be seen using this method. The same issue exists when using Kalman Filter (KF) methods, because in the update step of KF methods the minimum distance method is used to determine the next frame's matched cluster when measured with the next coordinates as predicted by the Kalman Filter.

In implementations of the object tracking method disclosed herein, a grid of the environment is first initialized wherein the space within the grid is divided into cells of one (1) square unit, such as one (1) square meter. A look-up map is generated that includes the assignment of a unique index to each cell. For example, the look-up map for a 200-meter radius sensing range includes: forwardmap[1]=(−200, −200), forwardmap[2]=(−200, −199), . . . , forwardmap[160000]=(200,200). A reverse look-up map is also generated that records the inverse relationship by returning the index given an (x,y)-coordinate query. For example, the reverse-look-up map for a 200-meter radius sensing range includes: reversemap[(−200, −200)]=1, . . . , reversemap[(200, 200)]=160000.

A frequency-grid map is then created, wherein an input of verified historical trajectory data (which may be historical trajectories without other near objects or trajectories that have been manually validated, otherwise known as accurate historical trajectories) is used that captures the frequencies of objects moving from one cell to another cell within the grid environment. This step creates the data structure that is crucial in deciding how to track a vehicle.

The frequency-grid map structure is a dictionary and/or a map with keys as a pair of two different cells and with values as the count of the frequency that the trajectories file observed a jump from the first cell to the second cell in a time period, for example, of 0.1 second. An example of the frequency-grid map cell in a time period of 0.1 second is (1, 2, 20), wherein 1 is the index of the coordinate grid cell (−200 meter, −200 meter), 2 is the index of the coordinate grid cell (−200 meter, −199 meter), and 20 is the transition frequency value from the cell coordinate (−200 meter, −200 meter) to the cell coordinate (−200 meter, −199 meter) in a 0.1 second time interval in the verified historical trajectories. The frequency-grid map structure contains this type of transition frequencies from each grid cell to all other grid cells in a specific time interval, generated from the verified historical trajectories. Thus, the frequency-grid map structure for a 0.1 second interval is different from the frequency-grid map structure for a 0.2 second interval.

Multiple frequency-grid maps may be created that correspond to different time intervals, for example 0.1 seconds, 0.2 seconds, 0.3 seconds, and the like. Specifically, the map for 0.1 seconds is the main data structure, and the maps for other time periods are used in an adaptive method to track objects when they are occluded in some data frames (each frame is 0.1 second) which is described below.

Accordingly, for clusters (objects) that appear in each successive frame, the procedure calculates the center point coordinate (x, y) of each cluster and converts the coordinate to the grid cell index, for example converting a center point in the range of (−200 ˜−199, −200 ˜−199) to the cell index 1. The process next predicts each cluster's next frame cell index based on the frequency-grid map of the 0.1 second interval, the predicted cell index is the one with the highest location transition frequency from the object's current frame cell index. In the next frame, a cluster at the predicted cell index is considered as the same (tracked) object. If there is no cluster at the predicted cell index, the prediction is updated and replaced by the cell index with the next highest transition frequency from the original cell index.

If occlusion occurs with an object in one or several frames, the frequency-grid map of the 0.1 second interval then cannot find the matched cluster in the next frame. In this case, frequency-grid maps of longer time intervals, such as 0.2 seconds, 0.3 seconds, and the like, are used to search (track) clusters of the same object in the next few frames.

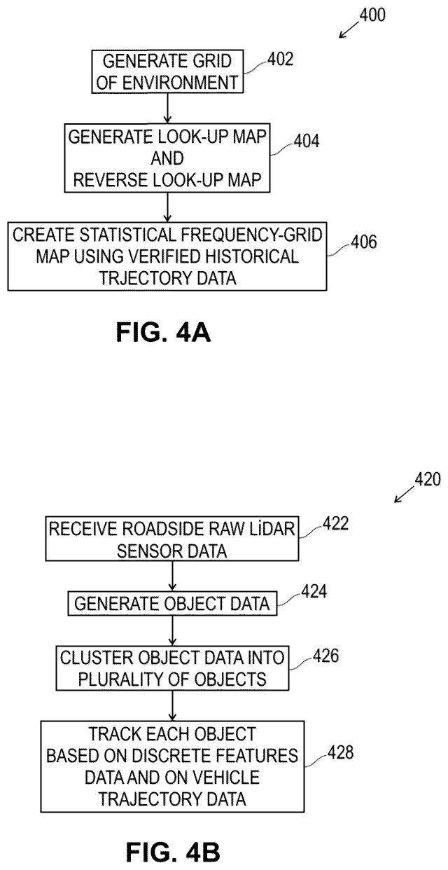

FIG. 4A is a flowchart 400 of an initialization process according to some embodiments. In some implementations of the object tracking method, a computer processor generates 402 a grid of the environment, wherein the space within the grid is divided into cells of one (1) square unit, for example, one (1) square meter. Next, the computer processor generates 404 both a look-up map wherein a unique index has been assigned to each cell, and a reverse look-up map that provides the inverse relationship or inverse index given an (x,y)-coordinate query. The process also includes creating 406, by the computer processor, a frequency-grid map using verified historical trajectory data that captures the frequencies of objects moving from one cell to another cell within the grid environment. The data structure of the frequency-grid map is crucial in deciding how to track a vehicle.

FIG. 4B is a flowchart 420 of a method for object tracking using roadside LiDAR sensor data in accordance with the disclosure. The process includes a computer processor of a computer receiving 422, from a roadside LiDAR sensor, raw LiDAR sensor data, then generating 424 object data by filtering background data from the raw LiDAR sensor data, and then clustering 426 the object data into a plurality of objects that include discrete features data. The process also includes the computer processor tracking 428 each object of the plurality of objects based on the discrete features data and based on vehicle trajectory data collected over a predefined time period over a length of roadway.

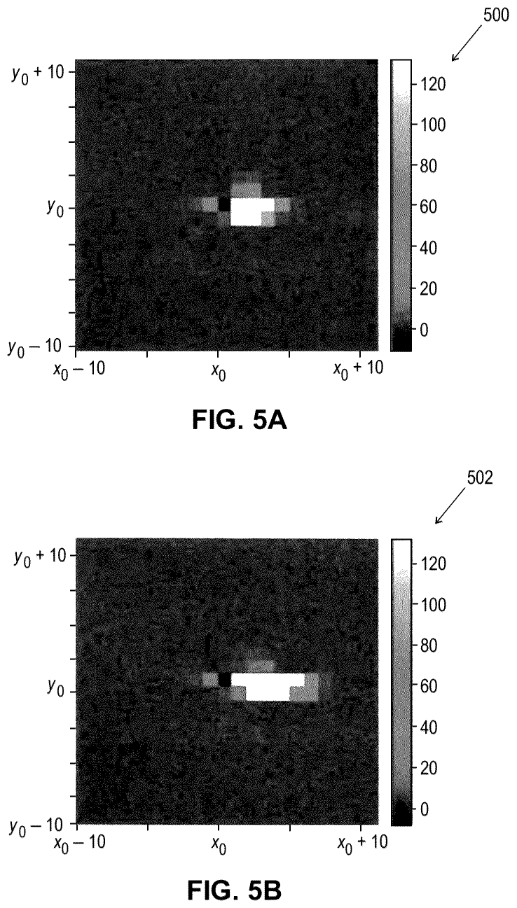

FIG. 5A illustrates an example heat map 500 of transfer frequencies from the center cell at a 0.1-second interval, whereas FIG. 5B illustrates an example heat map 502 of transfer frequencies from the center cell at a 0.2-second interval.

The accuracy of the results of the disclosed methods were evaluated in view of results from the use of popular and/or existing methods. Thus, the nearest distance method and the KF method were implemented.

The distance-based method was implemented as follows. The distances of the centroid of the vehicle from the previous frame were compared to the coordinates from each cluster in the next frame. The distances were then saved, and the mean of the distances corresponding to each cluster computed. The cluster with the minimum mean distance was then chosen to be the next tracked cluster where the distance metric is given by the Euclidean distance.

The Kalman Filter (KF) process is a recursive filtering algorithm for the optimal estimation of the current state of a process in the presence of noisy measurements by minimizing the residual error. It consists of a motion model where the prediction is made and an observed model where the update is made after tracking the object's new location. In an implementation, an object was chosen and the KF process started with that initial cluster's reference coordinates. The object's next location is predicted by the KF process and compared to clusters in the next frame, and matched to the nearest one. The new position, velocity, and direction of the object can be calculated with the tracked cluster and used to update the KF model.

The implementation of the KF method relied on the closest distance method to find the nearest cluster as the next measurement, and to determine the speed of the moving car. This may cause the same errors as the errors found in the distance method.

With regard to analyzing accuracy and trajectory continuity, there are several different types of tracking errors that can be observed including continued, missed, and wrong errors. Continued errors occur when the algorithm keeps matching objects to clusters in the following frames after the vehicle's true trajectory has ended. Missed errors occur when the algorithm misses a next cluster that should have been tracked and stops tracking the object. Wrong errors occur everywhere else when the next cluster is incorrectly matched.

A graphical user interface (GUI), which is a cluster labeling app, was used to compare the tracking results with the actual positions of vehicles over the same group of frames. The cluster labeling app was also used to generate the correct cluster labels between a vehicle which appears in two consecutive frames. The cluster labeling app's output can be loaded into arrays holding identifiers (IDs) that correspond to one vehicle's trajectory given a starting frame and an ending frame.

Advantageously, the disclosed method, which is a statistical approach to the tracking of vehicles in different settings such as highways and intersections, is efficient and accurate based on statistical counts of frequency of moving from one grid cell to another. Specifically, the disclosed method processes trajectories that have been recorded and verified to produce a map which indicates the most likely coordinates a vehicle should be located in (or moved to) given its past coordinates. The method advantageously achieves a higher accuracy rate as compared to some traditional methods, as well as providing improved and/or longer lengths of tracked trajectories.

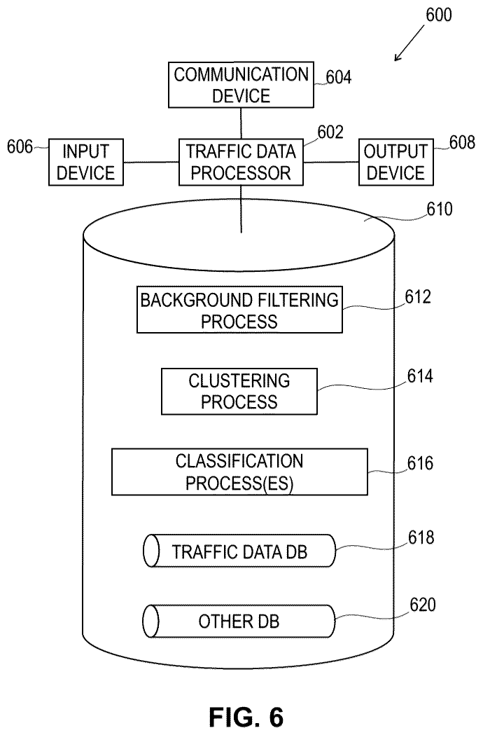

FIG. 6 is a block diagram of an object data processing computer 600 according to an embodiment. The object data processing computer 600 may be controlled by software to cause it to operate in accordance with aspects of the methods presented herein concerning processing object data generated by one or more roadside LiDAR sensors. In particular, the object data processing computer 600 may include an object data processor 602 operatively coupled to a communication device 604, an input device 606, an output device 608, and a storage device 610. However, it should be understood that, in some embodiments the object data processing computer 600 may include several computers or a plurality of server computers that work together as part of a system to facilitate processing of object data generated by a roadside LiDAR sensor or roadside LiDAR sensor system. In such a system, different portions of the overall method for facilitating object data processing of raw LiDAR sensor data may be provided by one or more computers in communication with one or more other computers such that an appropriate scaling up of computer availability may be provided if and/or when greater workloads, for example a large amount of raw traffic data from one or more LiDAR sensors, is encountered.

The object data processing computer 600 may constitute one or more processors, which may be special-purpose processor(s), that operate to execute processor-executable steps contained in non-transitory program instructions described herein, such that the object data processing computer 600 provides desired functionality.

Communication device 604 may be used to facilitate communication with, for example, electronic devices such as roadside LiDAR sensors, traffic lights, transmitters and/or remote server computers and the like devices. The communication device 604 may, for example, have capabilities for engaging in data communication (such as object data communications) over the Internet, over different types of computer-to-computer data networks, and/or may have wireless communications capability. Any such data communication may be in digital form and/or in analog form.

Input device 606 may comprise one or more of any type of peripheral device typically used to input data into a computer. For example, the input device 606 may include a keyboard, a computer mouse and/or a touchpad or touchscreen. Output device 508 may comprise, for example, a display screen (which may be a touchscreen that may be utilized as both an input device and an output device) and/or a printer and the like.

Storage device 610 may include any appropriate information storage device, storage component, and/or non-transitory computer-readable medium, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium.”

The term “computer-readable medium” as used herein refers to any non-transitory storage medium that participates in providing data (for example, computer executable instructions or processor executable instructions) that may be read by a computer, a processor or a like device. Such a medium may take many forms, including but not limited to, non-volatile media and volatile media. Non-volatile media may include, for example, optical or magnetic disks and other persistent memory. Volatile media may include dynamic random access memory (DRAM), which typically constitutes the main memory. Examples of computer-readable media include, but are not limited to, a floppy disk, a flexible disk, hard disk, magnetic tape, a solid state drive (SSD), any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in providing sequences of computer processor-executable instructions to a processor. For example, sequences of instruction (i) may be delivered from RAM to a processor, (ii) may be wirelessly transmitted, and/or (iii) may be formatted according to numerous formats, standards or protocols, such as Transmission Control Protocol, Internet Protocol (TCP/IP), Wi-Fi, Bluetooth, TDMA, CDMA, and 3G.

Referring again to FIG. 6, storage device 610 stores one or more programs for controlling the processor 602. The programs comprise program instructions that contain processor-executable process steps of the object data processing computer 600, including, in some cases, process steps that constitute processes provided in accordance with principles of the processes disclosed herein. In some embodiments, such programs include, for example, background filtering process(es) 612, clustering process(es) 614 and trajectory process(es) 616 to process object data received from one or more roadside LiDAR sensors.

The storage device 610 may also include one or more object data database(s) 618 which may store, for example, prior object trajectory data and the like, and which may also include computer executable instructions for controlling the object data processing computer 600 to process LiDAR sensor data and/or information to track vehicles and/or to determine vehicle trajectory. The storage device 610 may also include one or more other database(s) 620 and/or have connectivity to other databases (not shown) which may be required for operating the object data processing computer 600.

Application programs and/or computer readable instructions run by the object data processing computer 600, as described above, may be combined in some embodiments, as convenient, into one, two or more application programs. Moreover, the storage device 610 may store other programs or applications, such as one or more operating systems, device drivers, database management software, web hosting software, and the like.

As used herein, the term “computer” should be understood to encompass a single computer or two or more computers in communication with each other.

As used herein, the term “processor” should be understood to encompass a single processor or two or more processors in communication with each other.

As used herein, the term “memory” should be understood to encompass a single memory or storage device or two or more memories or storage devices.

As used herein, a “server” includes a computer device or system that responds to numerous requests for service from other devices.

As used herein, the term “module” refers broadly to software, hardware, or firmware (or any combination thereof) components. Modules are typically functional components that can generate useful data or other output using specified input(s). A module may or may not be self-contained. An application program (sometimes called an “application” or an “app” or “App”) may include one or more modules, or a module can include one or more application programs.

The above descriptions and illustrations of processes herein should not be considered to imply a fixed order for performing the process steps. Rather, the process steps may be performed in any order that is practicable, including simultaneous performance of at least some steps and/or omission of steps.

Although the present disclosure has been described in connection with specific example embodiments, it should be understood that various changes, substitutions, and alterations apparent to those skilled in the art can be made to the disclosed embodiments without departing from the spirit and scope of the disclosure.

What is claimed is:

1. A method for object tracking using raw roadside LiDAR sensor data comprising:
receiving, by a computer processor of a computer from a roadside LiDAR sensor, raw LiDAR sensor data;
generating, by the computer processor, object data by filtering out background data from the raw LiDAR sensor data;
clustering, by the computer processor, the object data into a plurality of clusters defining a plurality of objects, wherein each object comprises discrete features data;
classifying, by the computer processor, each object of the plurality of objects; and
tracking, by the computer processor, each classified object of the plurality of objects based on the discrete features data and on vehicle trajectory data collected over a predefined time period over a length of roadway.

2. The method of claim 1, further comprising, prior to receiving the raw LiDAR sensor data:
generating, by the computer processor, a grid of cells defining a grid environment in which objects travel;
generating, by the computer processor, a look-up map by assigning a unique index to each cell of the grid of cells; and
generating, by the computer processor, a reverse-look-up map by assigning a unique inverse index to each cell of the grid of cells.

3. The method of claim 2, further comprising generating, by the computer processor, a frequency-grid-map that captures movement of objects from one cell to another cell within the grid environment.

4. The method of claim 3, wherein the computer processor receives verified historical trajectory data that captures the frequencies of objects moving from one cell to another cell within the grid environment.

5. The method of claim 1, wherein the discrete features data comprises at least one of points, collections of edges, and lines.

6. The method of claim 1, wherein the predefined time period is twenty-four (24) hours over the length of roadway.

7. The method of claim 1, wherein generating the object data comprises:
identifying, by the computer processor based on spherical map input data, a plurality of core points that are within a window size;
labeling, by the computer processor, the core points on a spherical map;
joining, by the computer processor, the core points as different clusters according to connectivity of the core points;
determining, by the computer processor, that a non-core point is within a window of a core point and that the absolute value of the non-core point minus a core point is less than the window size;
specifying, by the computer processor, a cluster label for the non-core point; and
generating, by the computer processor, a labeled spherical map of object data.

8. The method of claim 7, wherein after joining the core points as different clusters:
determining, by the computer processor, at least one of that a non-core point is not within a window of a core point or that the absolute value of the non-core point minus a core point is greater than the window size;
labeling, by the computer processor, the non-core point as noise.

9. The method of claim 1, wherein classifying each object of the plurality of objects comprises:
determining, by the computer processor, a reference point for each cluster; and
classifying, by the computer processor based on the reference point for each cluster, different road users by utilizing at least one feature-based classification process combined with prior trajectory information.

10. A traffic data processing computer for tracking vehicles using raw roadside LiDAR sensor data comprising:
a traffic data processor;
a communication device operably connected to the traffic data processor; and
a storage device operably connected to the traffic data processor, wherein the storage device stores processor executable instructions which when executed cause the traffic data processor to:
receive raw LiDAR sensor data from a roadside LiDAR sensor;
generate object data by filtering background data from the raw LiDAR sensor data;
cluster the object data into a plurality of clusters defining a plurality of objects, wherein each object comprises discrete features data;
classify each object of the plurality of objects; and
track each classified object of the plurality of objects based on the discrete features data and on vehicle trajectory data collected over a predefined time period over a length of roadway.

11. The traffic data processing computer of claim 10, wherein the storage device stores further processor executable instructions which when executed cause the traffic data processor to:
generate a grid of cells defining a grid environment in which objects travel;
generate a look-up map by assigning a unique index to each cell of the grid of cells; and
generate a reverse-look-up map by assigning a unique inverse index to each cell of the grid of cells.

12. The traffic data processing computer of claim 11, wherein the storage device stores further processor executable instructions which when executed cause the traffic data processor to generate a frequency-grid-map that captures movement of objects from one cell to another cell within the grid environment.

13. The traffic data processing computer of claim 12, wherein the storage device stores further processor executable instructions which when executed cause the traffic data processor to receive verified historical trajectory data that captures the frequencies of objects moving from one cell to another cell within the grid environment.

14. The traffic data processing computer of claim 10, wherein the discrete features data comprises at least one of points, collections of edges, and lines.

15. The traffic data processing computer of claim 10, wherein the predefined time period is twenty-four (24) hours over the length of roadway.

16. The traffic data processing computer of claim 10, wherein the processor executable instructions for generating the object data include instructions which when executed cause the traffic data processor to:
identify, based on spherical map input data, a plurality of core points that are within a window size;
label the core points on a spherical map;
join the core points as different clusters according to connectivity of the core points;
determine that a non-core point is within a window of a core point and that the absolute value of the non-core point minus a core point is less than the window size;
specify a cluster label for the non-core point; and
generate a labeled spherical map of object data.

17. The traffic data processing computer of claim 16, wherein the processor executable instructions for joining the core points as different clusters include instructions which when executed cause the traffic data processor to:
determine at least one of that a non-core point is not within a window of a core point or that the absolute value of the non-core point minus a core point is greater than the window size; and
label the non-core point as noise.

18. The traffic data processing computer of claim 10, wherein the processor executable instructions for classifying each object of the plurality of objects include instructions which when executed cause the traffic data processor to:
determine a reference point for each cluster; and
classify, based on the reference point for each cluster, different road users by utilizing at least one feature-based classification process combined with prior trajectory information.
